(19) United States
(12) Patent Application Publication
(10) Pub. No.: US 2003/0038263 A1
(43) Pub. Date: Feb. 27, 2003

(54) Electromagnetic actuator for a fuel injector

(76) Inventors: Lorenzo Battistini, Cesena (IT); Massimo Neretti, San Lazzaro Di Savena (IT); Andrea Ricci, San Michele (IT)

Correspondence Address: BAKER & DANIELS, 111 E. WAYNE STREET, SUITE 800, FORT WAYNE, IN, 46802

(21) Appl. No.: 10/205,702

(22) Filed: Jul. 26, 2002

(30) Foreign Application Priority Data
Jul. 27, 2001 (IT) BO2001A000483

(51) Int. Cl. F16K 31/02

(52) U.S. Cl. 251/129.21

(57) ABSTRACT

Electromagnetic actuator for a fuel injector; the electromagnetic actuator is provided with an electromagnet, which has a fixed magnetic core which is delimited at the base by a first annular contact surface, and with an anchor, which is mechanically integral with a shutter, it can be displaced against the action of a spring towards the magnetic core by the effect of the force of magnetic attraction produced by the electromagnet, and is delimited at the top by a second annular contact surface, which is parallel to, and faces the first contact surface; between the two contact surfaces there is interposed an annular separation body, which is substantially flat, is made of non-magnetic material, and is integral with the magnetic core or with the anchor.

The present invention relates to an electromagnetic actuator for a fuel injector.

### BACKGROUND OF THE INVENTION

The known electromagnetic actuators for fuel injectors comprise an electromagnet which is controlled in order to displace an anchor which is connected mechanically to a shutter between a position of opening and a position of closure; the electromagnet has a fixed magnetic core which is delimited at the base by a first contact surface, whereas the anchor can be displaced against the action of a spring towards the magnetic core by the effect of the force of magnetic attraction produced by the electromagnet itself, and is delimited at the top by a second contact surface, which faces the first contact surface.

In order to prevent phenomena of magnetic adhesion, i.e. in order to prevent the armature from being attracted by the electromagnet with a force caused by the residual magnetism which is excessively high and higher than the return force generated by the spring, one or both of the contact surfaces are covered with a relatively thick layer of non-magnetic material, and typically chromium or nickel, which guarantees in all situations the presence of a gap which is sufficient to prevent phenomena of magnetic adhesion. A further function of the layer of nonmagnetic metal is to increase the hardness of the contact surfaces in order to reduce the wear of the contact surfaces themselves.

However, the known electromagnetic actuators of the above-described type have various disadvantages, since the method for depositing of the non-magnetic layer is relatively costly. In addition, the layer of non-magnetic metal can have relatively low hardness with obvious negative effects on the service life of the injector. Finally, in order to reduce the environmental impact of the components for vehicle drives, the standards are imposing increasingly stringent restrictions on the use of chromium.

### SUMMARY OF THE INVENTION

The object of the present invention is to provide an electromagnetic actuator for a fuel injector, which is free from the above-described disadvantages, and, in particular, is easy and economical to implement.

According to the present invention, an electromagnetic actuator is provided for a fuel injector as specified in claim 1.

### BRIEF DESCRIPTION OF THE DRAWINGS

The present invention will now be described with reference to the attached drawings, which illustrate some non-limiting embodiments of it, in which:

FIG. 1 is a schematic view in lateral elevation and partially in cross-section of a fuel injector produced according to the present invention;

FIG. 2 is a view on an enlarged scale of part of FIG. 1; and

FIGS. 3 and 4 are plan views of two alternative embodiments of a detail of FIG. 2.

### DETAILED DESCRIPTION OF THE INVENTION

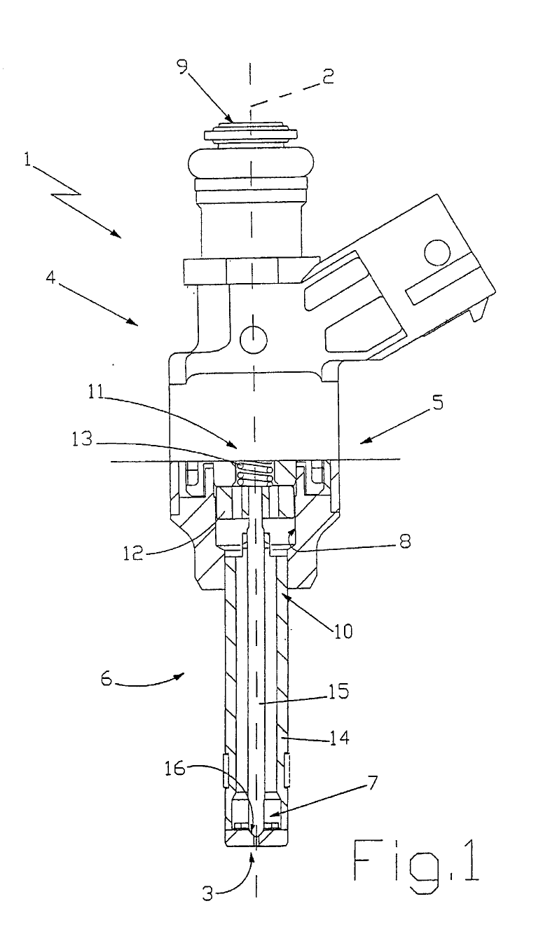

In FIG. 1, 1 indicates as a whole a fuel injector, which has substantially cylindrical symmetry around a longitudinal axis 2 and can be controlled in order to inject liquid fuel, and typically petrol or diesel, from the injector's own injection nozzle 3. The injector 1 comprises an upper actuator body 4 which accommodates an electromagnetic actuator 5, and a lower valve body 6, which is integral with the actuator body 4 and accommodates a valve 7 which is actuated by the electromagnetic actuator 5, in order to regulate the flow of fuel from the injection nozzle 3.

The actuator body 4 has a substantially cylindrical inner cavity 8, which receives the pressurised fuel from an upper supply aperture 9, ends in a lower aperture 10 which is engaged by the valve body 6, and accommodates the electromagnetic actuator 5.

The electromagnetic actuator 5 comprises a fixed electromagnet 11, which can displace an anchor 12 made of ferromagnetic material along the axis 2, from a position of closure (not illustrated) to a position of opening (illustrated in FIGS. 1 and 2) against the action of a spring 13 which tends to keep the anchor 12 in the position of closure.

The valve body 6 comprises a substantially cylindrical tubular container 14 which accommodates a shutter 15, which has an upper portion which is integral with the anchor 12 and co-operates with a valve seat 16 in order to regulate in a known manner the flow of fuel from the injection nozzle 3.

As illustrated in FIG. 2, the electromagnet 11 comprises a fixed magnetic core 17 with a cylindrical tubular shape which is delimited at the base by an annular contact surface 18, and a coil 19 which is disposed around the magnetic core 17; the anchor 12 has a cylindrical tubular shape and is delimited at the top by an annular contact surface 20, which faces the contact surface 18, and has substantially the same dimensions as the contact surface 18 itself. The magnetic core 17 has a central channel 21, which permits the flow of fuel towards the valve body 6 and accommodates the spring 13; the anchor 12 has an annular channel 22 which is connected to the channel 21 and permits the flow of the fuel towards the valve body 6.

Between the two contact surfaces 18 and 20 there is interposed a separation body 23, which is substantially flat, is made of non-magnetic material, and is integral with the magnetic core 17; according to a different embodiment not illustrated, the separation body 23 is integral with the anchor 12.

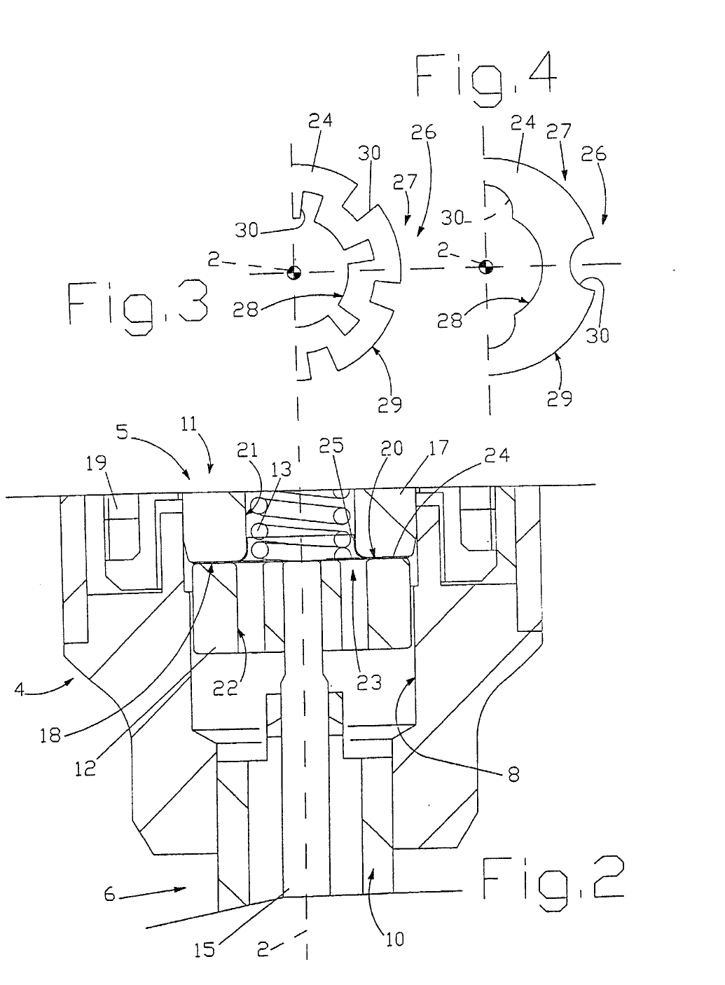

The separation body 23 has a flat element 24 (of which two alternative embodiments are illustrated in FIGS. 3 and 4), which is relatively thin (no thicker than 0.12 mm), has an annular shape, is interposed between the two contact surfaces 18 and 20, and has substantially the same dimensions as the contact surfaces 18 and 20. There is integral with the flat element 24 a cylindrical tubular element 25, which can be connected to an inner surface of the channel 21 in order to fulfil substantially a function of positioning and centring of the separation body 23 relative to the magnetic core 17.

According to a preferred embodiment, the separation body 23 is rendered integral with the magnetic core 17 by means of welding spots (not illustrated); in addition or as an alternative, the separation body 23 is rendered integral with the magnetic core 17 by embedding the cylindrical element 25 in the channel 22.

When the anchor 12 is displaced towards the magnetic core 17 in order to bring the contact surface 18 into contact with the flat element 24 of the separation body 23, the fuel which is present in the area contained between the contact surface 18 and the separation body 23 must be ejected from this area; this ejection of the fuel generates a fluid mechanics force which tends to slow down the course of the anchor 12, and thus tends to increase the time which is necessary for opening of the injection nozzle 3. When the anchor 12 is spaced from the magnetic core 17 in order to separate the contact surface 18 from the flat element 24, fuel must flow towards the area contained between the contact surface 18 and the flat element 24; this flow of fuel generates a fluid mechanics force which tends to slow down the course of the anchor 12, and thus tends to increase the time necessary for closure of the injection nozzle 3.

The separation body 23 is provided with flow means 26, which can assist the flow of the fuel from and to the area contained between the contact surface 18 and the flat element 24, and can thus reduce the fluid mechanics forces which slow down the manoeuvring times of the injector 1.

The flat element 24 is delimited laterally by a perimeter surface 27, which is perpendicular to the contact surfaces 18 and 20 and is subdivided into an inner portion 28 and an outer portion 29; in order to assist the flow of fuel from and to the area contained between the contact surface 18 and the flat element 24, the flow means 26 comprise a plurality of blind channels 30, which are provided in the flat element 24, are through channels transversely, and can be straight and radial (FIG. 3) or can have other forms (FIG. 4), and open alternatively onto the inner portion 28 and onto the outer portion 29 of the perimeter surface 27.

The purpose of the channels 30 is to reduce the actual area of the flat element 24, such that this effective area of the flat element 24 is smaller than the area of the contact surface 18 (which is the same as the area of the contact surface 20) in accordance with the structural constraints imposed by the feasibility and ease of fitting at a low cost of the separation body 23; in fact, the smaller the effective area of the flat element 24 is compared with the area of the contact surface 18, the greater the space which can be used by the fuel to flow from and to the area contained between the contact surface 18 and the flat element 24.

From an alternative point of view, the purpose of the channels 30 is to maximise the area of the perimeter surface 27 by maximising the length of the perimeter surface 27 itself in accordance with the structural constraints imposed by the feasibility and ease of fitting at a low cost of the separation body 23; in fact, the larger the area of the perimeter surface 27 (for the same thickness of the flat element 24), the greater the area through which the fuel can flow from and to the area contained between the contact surface 18 and the flat element 24.

In order to guarantee in all conditions a minimum gap between the contact surfaces 18 and 20, and thus to avoid phenomena of magnetic adhesion between the contact surfaces 18 and 20 themselves, the separation body 23 is made of nonmagnetic material, and in particular of non-magnetic steel for springs of the family 300, which steel has a high level of surface hardness in order to reduce the wear of the two contact surfaces 18 and 20.

From the foregoing description, it is apparent that use of the separation body 23 makes it possible simply and very economically to avoid phenomena of magnetic adhesion between the contact surfaces 18 and 20; in addition, use of the separation body 23 makes it possible to reduce considerably the time necessary for the intake/output of the fuel in the area contained between the contact surface 18 and the separation body 23, thus reducing the response times of the injector 1.

1. Electromagnetic actuator for a fuel injector (1); the electromagnetic actuator (4) comprising an electromagnet (11), which has a fixed magnetic core (17) which is delimited at the base by a first annular contact surface (18), and an anchor (12), which can be displaced towards the magnetic core (17) by the effect of the force of magnetic attraction produced by the electromagnet (11) and is delimited at the top by a second contact surface (20), which is parallel to, and faces the first contact surface (18); the actuator being characterised in that between the two contact surfaces (18, 20) there is interposed a separation body (23), which is made of nonmagnetic material.

2. Actuator according to claim 1, wherein the said separation body (23) has a thickness, i.e. a dimension perpendicular to the said contact surfaces (18, 20), which is no greater than 0.12 mm.

3. Actuator according to claim 1, wherein the said separation body (23) is integral with the said magnetic core (17).

4. Actuator according to claim 1, wherein the said separation body (23) is integral with the said anchor (12).

5. Actuator according to claim 1, wherein the said magnetic core (17) and the said anchor (12) have a cylindrical tubular shape which is provided with a central channel (21, 22) for the fuel; the said contact surfaces (18, 20) being annular surfaces.

6. Actuator according to claim 5, wherein the said separation body (23) comprises a flat element (24) with an annular shape, which is interposed between the said contact surfaces (18, 20).

7. Actuator according to claim 6, wherein the said flat element (24) with an annular shape has substantially the same diameter as the said contact surfaces (18, 20).

8. Actuator according to claim 6, wherein the said separation body (23) comprises a tubular cylindrical element (25), which is integral with the said flat element (24) and can be connected to an inner surface of the said channel (21, 22).

9. Actuator according to claim 8, wherein the said separation body (23) can be rendered integral with the said magnetic core (17) or with the said anchor (12) by embedding the said tubular cylindrical element inside the said channel (21 ,22).

10. Actuator according to claim 1, wherein the said separation body (23) comprises flow means (26) which can assist the flow of the fuel from and to the space contained between the said two contact surfaces (18, 20).

11. Actuator according to claim 10, wherein the said separation body (23) comprises a flat element (24), which is interposed between the said contact surfaces (18, 20) and is delimited laterally by a perimeter surface (27) which is perpendicular to the contact surfaces (18, 20); the said flow means (26) being able to maximise the area of the said perimeter surface (27) by maximising the length of the surface (27) of the perimeter itself.

12. Actuator according to claim 10, wherein the said separation body (23) comprises a flat element (24), which is interposed between the said contact surfaces (18, 20); the said flow means being able to make the effective area of the flat area (24) smaller than the area of the contact surfaces (18, 20) themselves.

13. Actuator according to claim 12, wherein the said flat element (24) has cavities (30).

14. Actuator according to claim 12, wherein the said cavities (30) define blind channels which are through channels transversely.

15. Actuator according to claim 13, wherein the said flat element (24) is delimited laterally by a perimeter surface (27) which is perpendicular to the contact surfaces (18, 20); the said cavities (30) opening onto the said perimeter surface (27).

16. Actuator according to claim 15, wherein the said perimeter surface (27) comprises an inner portion (28) and an outer portion (29); the said cavities (30) opening alternatively onto the said inner portion (28) and onto the said outer portion (29) of the perimeter surface (27).

17. Actuator according to claim 13, wherein the said cavities (30) are radial cavities.

18. Actuator according to claim 1, wherein the said separation body (23) is made of non-magnetic metal which has a high level of surface hardness.

19. Actuator according to claim 18, wherein the said separation body (23) is made of non-magnetic steel for springs of the family 300.
